(19) United States
(12) Patent Application Publication
(10) Pub. No.: US 2008/0072402 A1
(43) Pub. Date: Mar. 27, 2008

(54) PARTICLE DOUBLETS AND N-MERS AND METHODS FOR FABRICATION THEREOF

(75) Inventors: Darrell Velegol, State College, PA (US); Allison M. Yake, State College, PA (US); Joseph J. McDermott, State College, PA (US)

Correspondence Address: GIFFORD, KRASS, SPRINKLE,ANDERSON & CITKOWSKI, P.C, PO BOX 7021, TROY, MI, 48007-7021, US

(73) Assignee: The Penn State Research Foundation, University Park, PA (US)

(21) Appl. No.: 11/858,536

(22) Filed: Sep. 20, 2007

Related U.S. Application Data
(60) Provisional application No. 60/826,486, filed on Sep. 21, 2006.

(51) Int. Cl. B01F 3/12

(52) U.S. Cl. 23/313 AS

(57) ABSTRACT

Methods of producing a plurality of particle aggregates having a specified number of member particles are provided according to embodiments of the present invention. Specific methods include stimulating a plurality of particles with an aggregation stimulus to form a plurality of particle aggregates and then quenching the aggregation stimulus in order to inhibit further particle aggregation. An individual particle aggregate of the produced plurality of particle aggregates has member particles including at least a first member particle and a second member particle. Member particles of particle aggregates are optionally subjected to fusion to stabilize the particle aggregates. Produced particle aggregates having a specified number of member particles may be purified to enrich for particular aggregates.

### REFERENCE TO RELATED APPLICATION

This application claims priority from U.S. Provisional Patent Application Ser. No. 60/826,486, filed Sep. 21, 2006, the entire content of which is incorporated herein by reference.

### FIELD OF THE INVENTION

The present invention relates generally to formation of particle aggregates. Specific embodiments of the present invention relate to methods for formation of particle homodoublets and formation of particle heterodoublets, particle homotriplets, particle heterotriplets and other particle aggregates having a defined number of member particles.

### BACKGROUND OF THE INVENTION

Particles having a defined size and shape, and particularly non-spherical particles, such as particle doublets, are highly desirable in diverse technologies including films, coatings, adhesives, photonic devices, drug delivery, biosensors, and functional materials. To the inventors' knowledge, no previous methods for the scalable production of particle aggregates having a defined number of member particles have been described.

Novel methods which allow large-scale production of particle aggregates having a defined number of member particles and compositions of such particle aggregates are required.

### SUMMARY OF THE INVENTION

Methods of producing a plurality of particle aggregates is provided according to embodiments of the present invention which includes stimulating a plurality of particles with an aggregation stimulus to form a plurality of particle aggregates and quenching the aggregation stimulus in order to inhibit further particle aggregation. An individual particle aggregate of the produced plurality of particle aggregates has member particles including at least a first member particle and a second member particle.

Methods according to the present invention are described which include fusing member particles of particle aggregates to stabilize the particle aggregates.

Individual particles of the plurality of particles to be exposed to the aggregation stimulus have any of various shapes. Illustratively, individual particles of the plurality of particles exposed to the aggregation stimulus are spherical, spherical flattened in one region, cubic, ellipsoidal, prolate spheroid, oblate spheroid, rods, plates, discs, toroid, irregular, flattened, or hollow. In particular embodiments, the plurality of particles are substantially spherical.

Singlet particles to be exposed to the aggregation stimulus in embodiments of methods according to the present invention for forming particles aggregates have a particle diameter in the range of about 1 nanometer to 100 microns, inclusive. In further embodiments, the singlet particles have a particle diameter in the range of about 10 nanometers to 20 microns, inclusive.

Methods according to embodiments of the present invention produce aggregates in which member particles all have substantially the same composition such that the particle aggregate is a homoaggregate. Further methods of the present invention are detailed in which aggregates are produced wherein at least two member particles have different compositions such that the particle aggregate is a heteroaggregate.

The member particles of particle aggregates produced according to embodiments of the present invention are organic polymer particles, metal particles, semiconductor particles, oxide particles or oil droplets. Particles composed of combinations of these materials are also contemplated. In particular embodiments, the particles are solid. In further embodiments, the particles are semi-solid or liquid.

Particles to be exposed to the aggregation stimulus in methods according to embodiments of the present invention have a core-shell configuration of material composition, that is have a core and a coating disposed on the core. In a particular embodiment, core-shell particles are used in which the core is a metal core and the coating is a polymer coating. In particular embodiments, particles have a layered compositional configuration, that is, at least three layers of are present.

Particles to be exposed to the aggregation stimulus in methods according to embodiments of the present invention include one or more ionic moieties. In particular embodiments, substantially all of the particles of the plurality of particles to be exposed to the aggregation stimulus have the same positive or negative charge.

Typically, the incubation time period between the aggregation stimulus and the quenching is in the range of about 0.1-10⁹ (i.e., one tenth to one billion), inclusive, times the Smoluchowski rapid flocculation time.

Optionally, the member particles of the produced particle aggregates are fused. In particular embodiments, the particle aggregates produced according to methods of the present invention are incubated at a temperature at or above the glass transition temperature of a polymer included in a member particle. In a further option, the particle aggregates are contacted with a solvent, effectively reducing the glass transition temperature of at least one of the member particles.

Compositions are provided according to embodiments of the present invention including at least one particle aggregate, the particle aggregate having at least a first member particle and a second member particle. Member particles may be composed of organic material, inorganic material or may have both organic and inorganic material components. Compositions are provided according to embodiments of the present invention including at least one particle aggregate, the particle aggregate having at least a first member organic polymer particle and a second member organic polymer particle. In further embodiments, compositions are provided according to embodiments of the present invention including at least one particle aggregate, the particle aggregate having at least a first member organic polymer particle and a second member particle which is an inorganic particle. Compositions are provided according to embodiments of the present invention including at least one inorganic particle aggregate, the inorganic particle aggregate having at least a first member inorganic particle and a second member inorganic particle. Examples of such inorganic particle aggregates include metal particle aggregates and semiconductor particle aggregates. Further examples of inorganic particle aggregates of the present invention include gold particle homodoublets including a first gold particle and a second gold particle, silver particle homodoublets including a first silver particle and a second silver particle, heterodoublets including a gold particle and a silver particle and silica homodoublet including a first silica particle and a second silica particle. In particular embodiments, methods and compositions are provided according to the present invention for producing particle aggregates wherein the member particles are in electrical communication.

### BRIEF DESCRIPTION OF THE DRAWINGS

FIG. 1 is a block diagram describing a method of producing non-spherical particle aggregates according to embodiments of the present invention;

FIG. 2 is a graphical illustration of a method of producing particle aggregates having a defined number of member particles according to embodiments of the present invention;

FIG. 3 is a graph illustrating the production of homodoublets as well as singlets, triplets and other particle n-mers achieved according to an example of a method of the present invention;

FIG. 4A is a reproduction of a Field Emission Scanning Electron Micrograph (FESEM) image of a homodoublet including two 2.1 micron diameter amidine PSL particles at 20000× magnification.

FIG. 4B is a reproduction of an FESEM image taken at 20000× magnification showing a homodoublet including two 2.1 micron diameter amidine PSL particles after fusion by heating above the glass transition temperature;

FIG. 5 is a graph showing zeta potentials of particles at stages of a process for producing particle aggregates according to embodiments of the present invention;

FIG. 6 is a graph showing the yield percentage of homodoublets and heterodoublets, single particles, and larger particle aggregates produced according to an embodiment of a method of the present invention;

FIG. 7 is a graph showing absorbance of a reaction mixture for forming doublets of 22 nm silica particles at a wavelength of 550 nm as a function of time; and

FIG. 8 is a graph showing absorbance of a reaction mixture for forming doublets of 80 nm silica particles at a wavelength of 550 nm as a function of time.

### DETAILED DESCRIPTION OF THE INVENTION

A method of producing particle aggregates is described according to the present invention which includes providing a plurality of particles, stimulating the plurality of particles with an aggregation stimulus to form a plurality of particle aggregates, wherein each individual particle aggregate includes at least two or more member particles, and then quenching the aggregation stimulus at a controlled time to inhibit further aggregation.

The plurality of particles provided and stimulated with the aggregation stimulus is a plurality of single particles, also called singlets herein. In further embodiments, the plurality of particles provided is a plurality of doublets, triplets, other n-mer aggregate, or a combination of these. The term “n-mer” refers to an aggregate having a specified number “n” member particles.

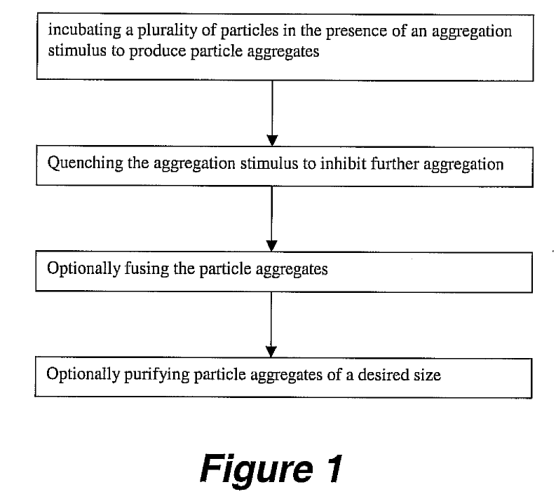

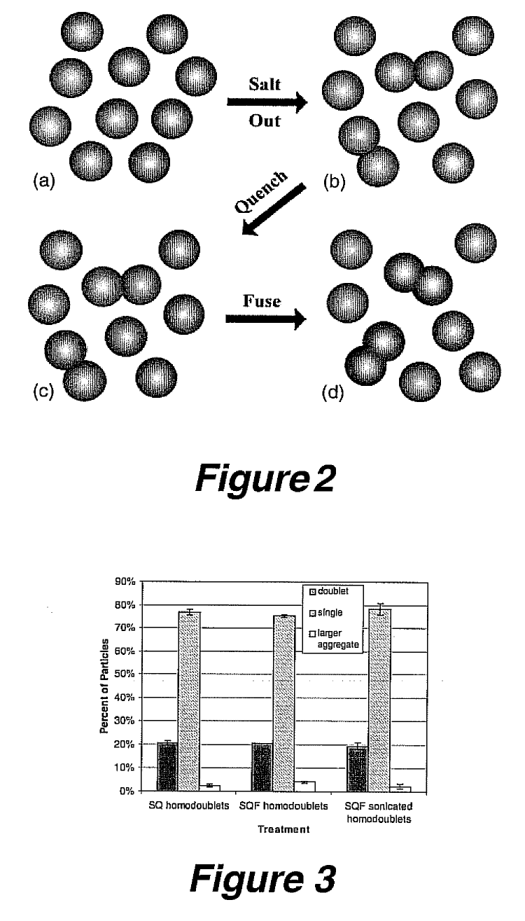

FIG. 1 is a block diagram describing a method of producing non-spherical particle aggregates according to embodiments of the present invention. FIG. 2 is a graphical illustration of a method of producing particle aggregates having a defined number of member particles according to embodiments of the present invention.

The aggregation stimulus used depends on the characteristics of the plurality of provided particles to be exposed to the aggregation stimulus. Particles to be aggregated are characterized by, for instance, the identity and number of ionic moieties present on the particles, the stability of the single particles in particular solvents, the presence and identity of a coating on a particle core, the shape of the particle, and the material composition of the particles.

In particular embodiments of methods of forming particle aggregates of the present invention, particles are provided as a colloidal dispersion including a continuous phase and a dispersed phase wherein the dispersed phase is the plurality of particles distributed in the continuous phase. For example, a colloidal dispersion of singlets, doublets, and/or triplets is provided for exposure to an aggregation stimulus. Higher n-mer aggregates are provided as a colloidal dispersion in further embodiments of the present invention.

A colloidal dispersion of single particles for use in a method of forming aggregates according to embodiments of the present invention is synthesized or obtained commercially. Exemplary methods for synthesis of single particle colloids are described herein.

A colloidal dispersion of doublets, triplets or other particle n-mers produced according to methods of the present invention is optionally provided for use in producing further particle aggregates. For example, in particular embodiments of the present invention, particle doublets produced according to methods described herein are provided for use in producing triplets or other n-mer aggregates. Optionally, particle doublets produced according to methods described herein and provided for use in producing triplets or other n-mer aggregates are substantially purified from singlets or non-doublet aggregates prior to use in producing triplets or other n-mer aggregates.

The continuous phase is liquid in particular embodiments of the present invention. The continuous phase is aqueous or non-aqueous depending on factors including the composition of the particles, the aggregation stimulus selected and the method used to quench the aggregation stimulus.

Broadly described, an aggregation stimulus is a change in the environment of the dispersed phase which reduces repulsive forces between the single particles. Illustrative aggregation stimuli to induce aggregation of single particles of the dispersed phase include increasing ionic strength of the continuous phase, changing pH of the continuous phase, adding or removing a solvent to the continuous phase, changing temperature, or adding a binding agent.

The extent of aggregation, that is, the number of member particles included in the individual aggregates predominantly produced, depends on the strength of the aggregation stimulus and the time allowed for aggregation. In particular embodiments of the present invention, the strength of the aggregation stimulus used to induce aggregation is selected in order to aggregate particles at the desired rate to control more precisely the number of member particles in the produced aggregates, given a certain amount of time.

In particular embodiments of methods according to the present invention for producing particle aggregates, the aggregation stimulus is a change in the ionic strength of the environment of the single particles. In such an embodiment, single particles are provided which include one or more ionic moieties such that the dispersion of the plurality of single particles is substantially stable due to electrostatic and/or electrosteric repulsion. Such ionic moieties illustratively include sulfate groups, carboxyl groups, silanol groups, amidine groups, amine groups, adsorbed ions, or substituted metal ions. Increasing the ionic strength of the environment of the plurality of single particles reduces the electrostatic and/or electrosteric repulsion, resulting in “salting out” of the particles wherein van der Waals attractive forces predominate such that particle aggregates are produced.

Where a change in ionic strength is used as an aggregation stimulus, the magnitude of the increase in ionic strength is selected in order to control the speed and extent of aggregation. A large increase in ionic strength will induce “rapid aggregation” of particles having an ionic moiety, the rapidity of aggregation limited by diffusion of the particles or the shear conditions in a system. A smaller increase in ionic strength gives a slower rate of aggregation and allows for finer control of the size of aggregates produced.

A change in temperature is an aggregation stimulus in particular embodiments of methods of producing particle aggregates of the present invention. Particle compositions responsive to a change in temperature as an aggregation stimulus include those particles whose steric coating layer expands or contracts in size in response to changes in temperature. For example, the steric coating layers expand or contract by absorbing or excluding either an aqueous or a non-aqueous solvent present in the continuous phase of a particle suspension, at a given temperature. An example of a polymer steric layer that collapses or expands with temperature in an organic fluid is the dispersant hypermer KD1 (a polyester/polyamine condensation polymer) in methyl ethyl ketone (MEK)/ethanol (E) solvents. Upon cooling, the solvency of the the dispersant in MEK/E decreases dramatically, reducing the stability of the particles suddenly. The solvency is reversible with temperature.

An example in which temperature change is used as an aggregation stimulus is illustrated by providing F108 Pluronic (PEO-PPO-PEO) polymer layered particles which contract or expand in aqueous media as the temperature is changed. A decrease in temperature results in contraction of the polymer layers, thereby reducing sterically mediated inhibition of particle collisions, allowing attractive van der Waals forces to predominate and particle aggregates to form. The aggregation stimulus is quenched by increase in temperature, resulting in expansion of the polymer layers, favoring repulsive forces between the particles.

The aggregation stimulus is quenched to inhibit further aggregation of particles when aggregates having a selected number of member particles are formed. Quenching of the aggregation stimulus includes removal or reduction of the aggregation stimulus and characteristics of the quenching depend on the type aggregation stimulus used. For example, where increasing ionic strength is the aggregation stimulus, ionic strength of the continuous phase is reduced, typically by dilution, to inhibit further aggregation. In a further example, where a change in pH is used as an aggregation stimulus, quenching includes return of pH to an original pH value where the particles were stable to aggregation.

Quenching of an aggregation stimulus follows the aggregation stimulus after a period of incubation time sufficient to form aggregates having a selected number of member particles. In particular embodiments of methods of the present invention, incubation time is varied to produce a plurality of aggregates characterized by presence of individual aggregates having a specified number of member particles. As described herein, produced aggregates having a specified number of member particles may be purified from other aggregates. In further embodiments, incubation time is varied to produce a plurality of aggregates characterized by individual aggregates predominantly having a specified number of member particles.

In particular embodiments of inventive methods, the period of time between the aggregation stimulus and quenching is approximately equal to, or within a factor of 2 to 5, the Smoluchowski flocculation time (τ). An estimate of this time (τ) for spheres is given by Equation (I),

$$τ \approx \frac{πη {a}^{3}}{2 kT φ} W \qquad ( I )$$

where π=3.14; η is the fluid viscosity (roughly 1.0 cP for water); a is the radius of the particles; kT is the thermal energy (k=1.38×10⁻²³ J/K; T is the absolute temperature); φ is the volume fraction of particles; and W is the stability ratio (number of particle collisions divided by the number of adherences). This estimate of τ represents the time scale required for half the singlets to aggregate by Brownian diffusion, which is quite comparable (within a factor of 10) to the time required for 10% of the particles to aggregate. Thus, for 1000 nm diameter silica spheres aggregating in water at T=298 K and a volume fraction of 10%, τ=0.42 sec under rapid flocculation (i.e., diffusion-limited, with W=1) conditions. In order to adjust τ and control the rate of aggregation, the volume fraction of particles (φ) is optionally adjusted. For example, if φ=0.001 in this example, τ=42 sec. Equation (I) can be adjusted for different particle shapes using known geometrical constants.

An alternative way to increase or decrease the time (τ) is to adjust W from roughly 1.0 (rapid aggregation) to another value. Since W is related exponentially to the energy potential barrier (Φ) between particles, by altering the stimulus, one adjusts Φ and thus adjusts W. One estimate of this relation is given by Equation (II),

$$W \approx 1 + 0.25 [ exp ( \frac{{Φ}_{max}}{kT} ) - 1 ] \qquad ( II )$$

One method for increasing Φ and thus increasing W is to reduce the ionic strength in a system. In the example given above, at a volume fraction of 10% particles, we could increase W to 100, corresponding roughly to a maximum repulsive barrier Φₘₐₓ/kT of about 6.0. Well-known, predictive equations exist relating the Φₘₐₓ to the particle surface potentials (in volts), the fluid permittivity, the particle radii, the Debye screening length (which depends in large part on the ionic strength), and the Hamaker constant of the particle-fluid-particle interactions (which describes the van der Waals forces in the system). In practice, these equations are used as a guide to the correct ionic strength required for controlled aggregation. One of skill in the art determines optimal values without undue experimentation.

One simple method for estimating the time required to form a substantial number of other particular aggregates (e.g., 3-mers, 4-mers, n-mers) is to use a multiple of a calculated rapid flocculation time. Although detailed modeling exists concerning such population balances, this quick method can be quickly tuned by experiments at the lab scale, for use in larger scale production processes. Thus, for example, in order to form a population of aggregates including predominantly triplet spherical particles, five times the calculated rapid flocculation time is an incubation time which may be used. Similar methods are used for other n-mers.

Where nanocolloidal particles are included as starting material for producing aggregates, the Smoluchowski rapid flocculation time can be less than a microsecond. In the example above, using 20 nm diameter spheres at a volume fraction of 10%, T=3.5 μsec. Continuous processing conditions may be used to produce desired aggregates where τ is small. Alternatively, a longer incubation time using a weaker aggregation stimulus can be useful to control the extent of aggregation. For example, in particular embodiments, the incubation time is increased by increasing the stability ratio (W).

Thus, in a method according to the present invention for forming aggregates including nanocolloid particles, a weaker stimulus may be used in conjunction with a longer incubation time prior to quenching. The incubation time is typically in the range of about 1-10⁹ times the Smoluchowslci rapid flocculation time.

For example, where a large increase in ionic strength is used as a stimulus to induce diffusion-limited aggregation, the incubation time may be in the range of about 0.1-10 times the Smoluchowslci rapid flocculation time. In further embodiments, where a smaller increase in ionic strength is used as a stimulus to induce aggregation, the incubation time may be longer, such as in the range of about 10²-10⁹ times the Smoluchowski rapid flocculation time.

Relatively high yields of particles having a defined number of member particles are achieved using an inventive method. For example, methods for producing doublets according to the present invention can yield a population of particles in which 40-50%, or more, of the particles are doublets.

Further preferred embodiments of a method according to the present invention for forming a particle aggregate include a fusion step for fusing the member particles to stabilize the particle aggregate.

The term “fusion” refers to treatment of particle aggregates which results in bonding of the component particles and/or mixing of atoms or molecules at least at the interface between adjacent individual particles in a particle aggregate. Fusion may be accomplished in any of various ways, illustratively including heating particle aggregates containing a polymer to a temperature at or above the glass transition temperature of the polymer. Alternatively or in combination with heating, a chemical fusion technique is optionally used. Broadly described, chemical fusion is incubation of a polymer in a solvent which lowers the glass transition temperature of the polymer. For example, exposure of polystyrene particles to toluene lowers the effective glass transition temperature of the polystyrene particles, resulting in mixing of polystyrene chains between adjacent individual particles in a particle aggregate.

The single particles, or singlets, used in methods according to embodiments of the present invention for forming aggregates may have any of various shapes and sizes. For example, single particles are illustratively spherical; spherical with one flattened region; cubic; ellipsoidal, such as prolate spheroid and oblate spheroid; cylinders; plates; discs; toroidal; irregular; or flattened. Single particles may have a hollow interior space such as a vesicle or tubular form; and/or the particles may have a core-shell structure, including with a layer-by-layer shell. In a particular embodiment of an inventive method, the single particles are substantially spherical.

The single particles used in methods according to embodiments of the present invention for forming aggregates each independently have a particle diameter in the range of about 1 nanometer to about 100 microns, inclusive, and in further embodiments, in the range of about 10 nanometers to about 20 microns, inclusive. In preferred embodiments, single particles are colloidal and/or nanocolloidal.

Aggregates formed according to methods of the present invention may be formed from any of various numbers of single particles. For instance, individual aggregates each have from 2-1000, or more, member particles. As noted above, the number of member particles in an aggregate is controlled by the aggregation stimulus inducing aggregation as well as the quenching of the stimulus in order to inhibit further aggregation. In preferred embodiments, aggregates are triplets, having three member particles. In additional preferred embodiments, the aggregates are doublets, having two member particles.

Aggregates may be formed from single particles having substantially the same composition to form homoaggregates. Alternatively, aggregates may be formed from single particles having various composition to form heteroaggregates.

The provided particles to be exposed to an aggregation stimulus to produce aggregates may each be any of various materials. For example, the particles may include one or more polymers, metals, semiconductors, oxides, or combinations of these or other materials. In certain embodiments, liquid droplets, such as droplets of oils are used. Exemplary oil droplets include droplets of hexane and droplets of paraffin.

Illustrative examples of polymers included in particles used to form particle aggregates according to embodiments of the present invention include organic thermoset and thermoplastic polymers. Specific examples of such polymers include polystyrene, polymethylmethacrylate, poly melamine formaldehyde. A polymer with a lower glass transition temperature includes polyvinyl acetate. Particles including mixtures of polymers are used to form particle aggregates according to embodiments of the present invention.

Illustrative examples of metal particles used to form particle aggregates according to embodiments of the present invention include gold, silver, platinum, and other transition metals. Particles including metal alloys may also be used to form particle aggregates.

Semiconductor particles illustratively used to form particle aggregates according to embodiments of the present invention include silicon and germanium. Particles including mixtures of semiconductors are used to form particle aggregates according to embodiments of the present invention.

Oxides which may be included in single particles illustratively include silica, alumina, zirconia, ceria and titania. Particles including mixtures of oxides are used to form particle aggregates according to embodiments of the present invention.

Single particles for use in a method of producing an aggregate of the present invention may be provided in solid form, as well as in the form of liquid droplets or as semi-solids such as gels.

The composition of single particles may be such that certain materials are substantially homogenously distributed throughout the particle. In other embodiments, particular materials are distributed preferentially at certain locations or in a patterned distribution. In one embodiment, single particles have a core-shell or coated configuration.

In a particular embodiment of a method of forming a particle aggregate of the present invention, particle doublets are formed. Each particle doublet formed in a method according to the present invention includes a first member particle and a second member particle. Optionally, the first member particle and the second member particle have substantially the same composition and size such that the particle doublet is a homodoublet. Alternatively, the first member particle has a different composition and/or size than the second member particle such that the particle doublet is a heterodoublet.

Methods of producing particle aggregates characterized by a desired number of member particles allow for large-scale production of particle aggregates characterized by a desired number of member particles. Methods of the present invention do not require a specialized support for formation of the particle aggregates characterized by a desired number of member particles and production of aggregates is generally performed in a liquid continuous phase. Aggregates produced according to embodiments of methods of the present invention are produced in concentrations in the range of about 10⁶/milliliter to 10¹⁷ or more/milliliter. In general, use of micron-size individual particles in a method for producing aggregates produces doublet concentrations in the range of about 10⁶/milliliter to 10¹⁰/milliliter and use of 10 nm diameter singlets individual particles in a method for producing aggregates produces doublet concentrations in the range of about 10¹⁰/milliliter to 10¹⁷/milliliter.

Optionally, an aggregate of a desired size produced according to a method of the present invention is purified from remaining single particles and/or larger or smaller aggregates. Purification methods include those capable of differentially selecting for particles or aggregates of different size, shape and/or composition. Differential centrifugation and/or filtration are particular techniques useful in purifying aggregates. In particular embodiments, density gradient centrifugation is used to purify selected aggregates. In further particular embodiments, disc stack centrifugation or tubular bowl centrifugation is used to purify selected aggregates.

A composition is provided according to the present invention which includes a particle aggregate having at least a first member particle and a second member particle. Particle aggregates have at least two and may have 1000 or more member particles. A composition including particle aggregates according to the present invention is enriched in aggregates having a specified number of member particles in preferred embodiments. For example, an inventive composition may be enriched in doublets (2-mers), triplets (3-mers), quadruplets (4-mers) and so on. An inventive composition may be enriched in an aggregate having a desired number of member particles by controlling aspects of aggregate formation, such as the strength and type of stimulus to induce aggregation, the time of incubation, the identity of the single particles and/or the quenching, for example. Further, an inventive composition may be enriched by purification to separate undesired aggregates from desired aggregates.

In further preferred embodiments, the particle aggregate is resistant to separation of the member particles. That is, the doublets are mechanically stable. In other cases, doublets that are mechanically less stable are desired, so that they can be split apart later.

In a particular embodiment, a composition is provided according to the present invention which includes a doublet particle having a first member particle and a second member particle. In preferred embodiments, the doublet particle is resistant to separation of the first member particle and the second member particle.

As noted above, particle aggregates according to the present invention may be homoaggregates or heteroaggregates, depending on the composition of the single particles used as starting material.

The member particles of a particle aggregate according to the present invention may have any of various compositions. For example, each member particle may include one or more polymers, metals, semiconductors, oxides, or combinations of these or other materials. Member particles may be solids, liquids, or semi-solids, such as gels.

The composition of single particles used to form a particle aggregate included in an inventive composition may be such that certain materials are substantially homogenously distributed throughout the particles. In other embodiments, particular materials are distributed preferentially at certain locations or in a patterned distribution. In one embodiment, single particles have a core-shell or coated configuration. For example, a single particle may have a metal core and a polymer coating.

Particle aggregate compositions according to the present invention include member particles having any of various shapes and sizes. For example, single particles included in a particle aggregate are illustratively cubic, ellipsoidal (e.g., prolate sphereoid, oblate spheroid), rods, plates, discs, toroid, irregular, and flattened particles. Single particles may have a hollow interior space such as a vesicle or tubular form. In a particular embodiment of an inventive method, the single particles are substantially spherical.

The single particles used to form an aggregate included in a composition according to the present invention each independently have a particle diameter in the range of about 1 nanometer to about 100 microns, inclusive, and in further embodiments, in the range of about 10 nanometers to about 20 microns, inclusive. In preferred embodiments, single particles are colloidal and/or nanocolloidal. Thus, a particle aggregate according to the present invention will have a shape and size dependent on the shape and size of the starting material. For example, doublet particles have an aggregate particle diameter in the range of about 2 nanometers to 200 microns, inclusive in particular embodiments.

A composition is provided in one embodiment that includes a mixture of particle aggregates having differing numbers of member particles. For instance, in one embodiment, a composition may include particle doublets and triplets; doublets, triplets and quadruplets (4-mers); doublets, triplets, quadruplets and quintuplets (5-mers); as well as other combinations of multiples of particle members. Alternatively, a composition may include particle aggregates having a specified number of member particles.

A composition according to the present invention is also provided which includes aggregates having a specified aggregate conformation. For example, an inventive triplet aggregate may have a conformation in which each member particle is in contact with two other member particles or a conformation in which two of the member particles are in contact with only one other member particle. Triplets having these individual conformations may be formed or purified such that a composition is enriched in a desired conformation. Similarly, quadruplets and other n-mers having particular conformations are provided in inventive compositions.

In further embodiments, as noted above, an inventive composition includes a particle doublet, triplet, quadruplet and quintuplet; or other multiple of particle members that has been substantially purified. Thus, in one such embodiment, a composition including a particle doublet is provided which is substantially free of single particles. In further embodiments, a particle doublet is provided which is substantially free of triplets or other larger particle aggregates.

It is appreciated that the relationship between stimulus strength and extent and/or speed of aggregation of single particles allows for measurement of the speed and/or extent of aggregation in order to infer the stimulus strength. In other words, methods according to the present invention allow for use in sensor applications.

In a further embodiment, single particles are provided which include one or more binding agent receptors such that placing the particles in contact with a binding agent results in aggregation of the particles. Such binding agents illustratively include receptor ligands, antibodies, and antigens.

Embodiments of inventive compositions and methods are illustrated in the following examples. These examples are provided for illustrative purposes and are not considered limitations on the scope of inventive compositions and methods.

### EXAMPLES

### Example 1

Mono disperse, surfactant-free amidine, sulfate, and carboxyl functionalized polystyrene latex (PSL), as well as carboxyl modified latex (CML) microspheres, are purchased from Interfacial Dynamics Corporation (Portland, Oreg.). Specifically, 2.1 micron diameter amidine functionalized PSL (Batch No: 1091,1), 3.3 micron diameter amidine functionalized PSL (Batch No: 1414,1), 2.4 micron diameter sulfate functionalized PSL (Batch No: 478,1), 2.0 micron diameter carboxyl functionalized PSL (Batch No: 2071,2), and 4.9 micron diameter carboxyl modified latex (Batch No: 2-387-76.C,1) microspheres are used in particular examples. Monodisperse, uniform, 1.54 micron diameter silica (Si) microspheres (Lot No: 5252) are used and are commercially available from Bang's Laboratory (Fishers, Ind.). Monodisperse, 2.02 micron diameter amino functional melamine formaldehyde (MF) microspheres (C-MF-2.00NH2) are used and are commercially available from the Corpuscular Company (Mahopac, N.Y.). Potassium Chloride (KCl, MW 74.55) is purchased from Sigma-Aldrich Chemicals, USA. The deionized (DI) water used, produced using a Millipore Corporation MilliQ system, has a specific resistance greater than 1 Mohm/cm, i.e., “equilibrium water” due to dissolved CO₂ in the water.

### Example 2

In this example of homodoublet formation, two hundred microliters of colloidal particle suspension including 4.2% particle solids is deposited in a test tube having an internal volume of 50 milliliters. Singlet particle starting material in this example is 2.1 micron diameter amidine functionalized PSL particles, 2.4 micron diameter sulfate functionalized PSL particles, or 2.0 micron diameter carboxyl functionalized PSL particles.

Two hundred microliters of a 500 mM KCL solution is added to the particle suspension, for a final ionic strength of 250 mM KCl. The test tube is swirled by hand so that the particles and the salt solution mix well.

After 60 seconds the aggregation process is quenched by adding 30 mL of deionized water to the test tube, giving a final ionic strength of 3.3 mM KCl, the electrostatic repulsions between the similarly charged particles preventing further aggregation. The final colloidal suspension contains singlets (unaggregated particles), homodoublets, and less than 3% of 3-mers (triplets) and 4-mers, with negligible 5-mers or higher n-mer aggregates.

The homodoublets formed are fused according to embodiments of the present invention to further stabilize them. In this example, the particles are heated above their glass transition temperature (T_{g}) of approximately 93° C., for 15 minutes such that the individual particles in the doublets permanently fuse to each other. The homodoublets are autoclaved at 120° C., 18 psi thereby exceeding T_{g} without boiling the fluid medium which may be water or another fluid.

Without the fusion step, the homodoublets break apart readily in deionized water in less than 1 minute of sonication using an ultrasonicator, VWR International Model 550T operated at 117 V, 270 avg Watt power, 40 kHz while with the fusion step the homodoublets can be sonicated at the same settings for more than 10 minutes with no change in the number of singlets or homodoublets.

The formed homodoublets are optionally purified from any remaining singlets or larger aggregates. In a particular example, an SQF sample is purified using density gradient centrifugation as described in Manoharan, V. N. et al., Science 2003, 301, 483-487; and Price, C. A., Centrifugation in Density Gradients. Academic Press: New York, 1982; p. 430, to achieve a composition containing at least 70-80% homodoublets. For example, a density gradient of 400 kg/m⁴ for these gradients may be used, over separation distances of 5 to 10 cm. Volume fractions of particles range from 10⁻⁶ to 10⁻³, and the separation occurs at 1 g (no centrifugation) to 1000 g.

Optical microscopy using a Nikon Eclipse TE2000-U inverted optical microscope at a magnification of 40× is used to monitor homodoublet formation and stability at various stages in a method according to the present invention.

In this example, optical microscopy images of aliquots of solutions used in the formation of homodoublets of 2.1 micron diameter amidine PSL are obtained and analyzed to determine the relative numbers and types of particles present following the salting out and quenching steps (SQ), after the fusing step (SQF), and after sonication of the SQF homodoublet solution.

FIG. 3 shows the yield of homodoublets as well as singlets, triplets and other particle n-mers achieved according to an embodiment of a method of the present invention in this example. The first set of bars gives the percentage of particles present in the homodoublet solution formed from the salting out and quenching steps (SQ), the second set is for the homodoublet solution after the fusing step (SQF), and the third set is for the SQF homodoublet solution after it is sonicated for 10 minutes using an ultrasonicator, VWR International Model 550T. Each experiment is performed at least five times, and about 1000 particles per sample are counted. The doublet fraction is calculated by dividing the number of doublets by the total number of singlets, doublets, triplets or other n-mers, of which there are very few. The same percentage of singlets and homodoublets exists after the quenching step, the fusion step, and the ultrasound sonication step, indicating the reliability of the process.

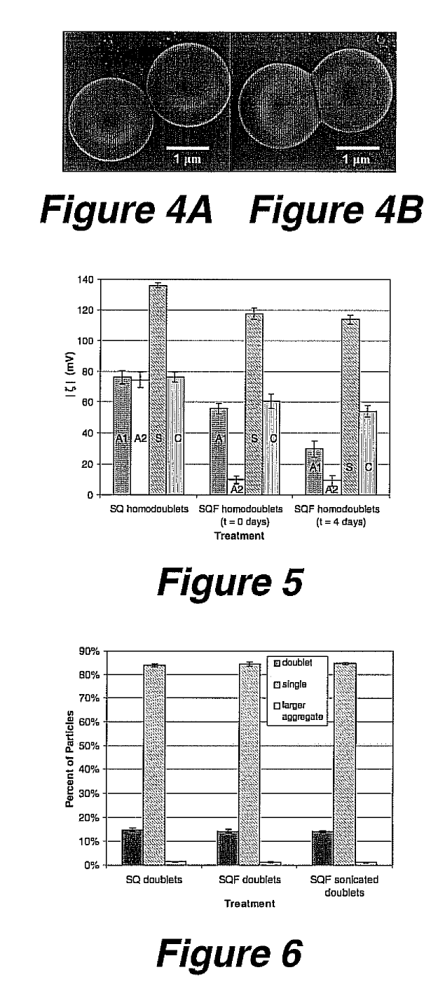

To further verify that the individual particles in obtained homodoublets are stably fused together into a particle doublet, FESEM images are taken of 2.1 micron diameter amidine homodoublets after the SQ steps and after the SQF steps. FIG. 4A shows an FESEM image of a homodoublet including two 2.1 micron diameter amidine PSL particles at 20000× magnification. The two particles are touching, but the perimeters of the particles remain well-defined. FIG. 4B shows an FESEM image of a similar homodoublet at 20000× magnification including 2.1 micron diameter amidine PSL particles after fusion by heating above the glass transition temperature.

### Example 3

A range of ionic strengths for the salting out step is tested, and optimized to obtain an effective salt concentration where doublets and/or triplets form with a high yield. A range of salt concentrations from 50 mM to 2 M is tested as an aggregation stimulus. A salt concentration of 500 mM is selected for use in these examples of doublet and triplet aggregate formation in conjunction with an incubation time of 60 seconds before quenching. Higher salt concentrations shortened the aggregation time and often resulted in more larger aggregates forming. Lower salt concentrations result in formation of fewer doublets and triplets. Incubation times from a few seconds to several minutes are used.

### Example 4

Homodoublets of 2.4 micron diameter sulfate PSL particles and 2.0 micron diameter carboxyl PSL particles are formed as described in Example 2. Optical microscopy images are obtained and percentages of singlets, homodoublets and larger aggregates in these preparations are substantially similar within experimental error compared to preparations using amidine PSL particles to produce amidine PSL homodoublets. The data from optical image analysis and the statistical percentages of homodoublets, singles and larger aggregates, indicate that the homodoublets formed are permanently fused after high pressure heating to above their T_{g}.

### Example 5

Zeta potentials of the amidine, sulfate, and carboxyl PSL homodoublet suspensions described in Examples 2 and 4 are taken as homodoublet solutions (SQ), both immediately after temperature fusing (SQF) and 4 days after the fusing process occurred. The particle zeta potentials are measured on a Brookhaven Instruments PALS (Phase Analysis Light Scattering) zeta potential analyzer. Colloidal particle zeta potentials are measured in a 10 mM KCl solution. The results are shown in FIG. 5 which shows a plot of the magnitude of the zeta potentials of various homodoublets during the SQF process. After the salting out and quenching steps (SQ), the zeta potentials have the highest magnitude. Most magnitudes of |ζ| drop slightly after the fusion step (SQF), although A2 dropped more significantly. In addition, the A1 amidine zeta potential continues to drop over 4 days. A1 is for 2.1 micron diameter amidine PSL for trials 1, 3, 4, 6, and 9. A2 is for the amidine particles after trials 2, 5, 7, 8, and 10. No known difference in handling occurred between A1 and A2. S is for the 2.4 micron diameter sulfate PSL particles (negatively-charged), and C is for the 2.0 micron diameter carboxyl PSL particles (also negatively-charged). The zeta potentials for sulfate particles and carboxyl particles do not change much during the steps of the SQF process, indicating that the temperature fusion step does not affect the charge groups significantly. However, the zeta potentials for some of the amidine particles do change, especially after the fusion step. All particles showed a statistical drop in magnitude of zeta potential after the temperature fusion step. Without wishing to be bound by theory, the drop in the zeta potential of the amidine functionalized PSL particles is likely due to a decomposition of the NH₂ group or the double bonded nitrogen from an influence of temperature as detailed in Kolthoff, I. M.; Miller, I. K. J. Am. Chem. Soc. 1951, 73, 3055-3059. Furthermore, out of the ten zeta potential experiments for amidine done after the fusion step and performed for ten different beakers of suspension, half degraded to +55 mV and half to +10 mV. Without wishing to be bound by theory, it is believed that the decrease in surface charge is attributable to hydrolysis of the surface functional groups due to the heat treatment as described in detail in Seebergh, J. E.; Berg, J. C. Colloids and Surfaces A. 1995, 100, 139-153. Specifically, some of the amidine groups hydrolyze and form uncharged amide groups, thus reducing the zeta potential of the doublet solution.

### Example 6

A solution of 4.9 micron diameter sulfate-functionalized polystyrene latex (PSL) homodoublets is formed in-suspension according to an embodiment of a method of the present invention. One hundred fifty microliters of 4.9 micron diameter sulfate-functionalized PSL microspheres are pipeted into the bottom of a 50 mL test tube. Next, 100 microliters of a 500 mM KCl solution are added to the particles in the bottom of the test tube. The test tube is gently agitated by hand for 60 seconds completing the salting out step. After 60 seconds, the particle aggregation reaction is quenched by adding 30 mL of deionized water. The homodoublets are then fused together by placing the salted out and quenched solution (SQ) in a standard steam autoclave for 15 minutes at 120° C. at 18 psi. After fusing, the solution is left to cool to room temperature. Typically, a homodoublet yield of about 46.8±10.2% is achieved using this procedure.

### Example 7

Triplet particles are formed in this example. Two hundred microliters of colloidal particle suspension including 4.2% particle solids is deposited in a test tube having an internal volume of 50 milliliters. Singlet particle starting material in this example is 2.4 micron diameter sulfate functionalized PSL particles.

Two hundred microliters of a 500 mM KCL solution is added to the particle suspension, for a final ionic strength of 250 mM KCl. The test tube is swirled by hand so that the particles and the salt solution mix well.

After 60 seconds the aggregation process is quenched by adding 30 ml of deionized water to the test tube, giving a final ionic strength of 3.3 mM KCl, the electrostatic repulsions between the similarly charged particles preventing further aggregation. The final colloidal suspension is applied to a density gradient in a centrifuge tube. A sucrose solution with a density gradient of 400 kg/m⁴ over a distance of 5 to 10 cm is useful for this purification; this corresponds to roughly 5% sucrose to 12%, and higher or lower percentages may be used. The particles are either settled at 1 g (i.e., 9.8 m/s²) or centrifuged at 10-1000 g for a time consistent with their settling rate as given by Stokes law. For settling at 1 g, this is often 2 days. At 100 g, this is 30-45 minutes. A discrete band containing substantially pure triplet aggregates is optically apparent in the centrifuge tubes following centrifugation or settling. The band is removed from the tube, isolating the substantially pure triplet aggregates.

### Example 8

Triplet particles are formed in this example. Two hundred microliters of colloidal particle suspension including 4.2% particle solids is deposited in a test tube having an internal volume of 50 milliliters. Singlet particle starting material in this example is 2.4 micron diameter sulfate functionalized PSL particles.

Two hundred microliters of a 500 mM KCL solution is added to the particle suspension, for a final ionic strength of 250 mM KCl. The test tube is swirled by hand so that the particles and the salt solution mix well.

After 60 seconds the aggregation process is quenched by adding 30 mL of deionized water to the test tube, giving a final ionic strength of 3.3 mM KCl, the electrostatic repulsions between the similarly charged particles preventing further aggregation. The final colloidal suspension is applied to a 400 kg/m⁴ sucrose density gradient in a centrifuge tube and centrifuged at 1 to 100 g for an appropriate time to settle 5-10 cm. A discrete band containing substantially pure doublet aggregates is optically apparent in the centrifuge tubes following centrifugation. The band is removed from the tube, isolating the substantially pure doublet aggregates.

Two hundred microliters of colloidal particle suspension including equal parts of a suspension of the isolated substantially pure doublet aggregates and a suspension of singlet particles is deposited in a test tube having an internal volume of 50 milliliters.

Two hundred microliters of a 500 mM KCL solution is added to the particle suspension, for a final ionic strength of 250 mM KCl. The test tube is swirled by hand so that the particles and the salt solution mix well.

After 60 seconds the aggregation process is quenched by adding 30 mL of deionized water to the test tube, giving a final ionic strength of 3.3 mM KCl, the electrostatic repulsions between the similarly charged particles preventing further aggregation. Resulting triplet particles are optionally purified from the final suspension.

### Example 9

Heterodoublets are formed in this example. 37.3 microliters of 2.4 micron diameter sulfate functionalized PSL and 149.2 microliters of 4.6 micron diameter CML particles, 4.1% solids, are mixed in a test tube. The sulfate functionalized PSL and CML particles are different sizes and had different negative zeta potentials. Two sizes of colloidal particles are used for the heterodoublet formation processing order to optically distinguish the two differently functionalized particles.

Two hundred microliters of a 500 mM KCL solution are added to the particle suspension, for a final ionic strength of 250 mM KCl. The test tube is slowly swirled by hand so that the particles and the salt solution mix well. At 250 mM KCl, the particles aggregate quickly, and thus the particles are “salted out” to form aggregates.

After 60 seconds the aggregation process is quenched by adding 30 mL of deionized water to the test tube, giving a final ionic strength to 3.3 mM KCl. The quenched colloidal suspension contains singlet, unaggregated particles, homodoublets, heterodoublets, and less than 3% of 3-mers (triplets) and 4-mers, with negligible 5-mers and beyond.

Toluene was added to the salted out—quenched particle samples and used with heat to fuse the particles. Both 5% and 10%,by weight, solutions of toluene that were heated to 80° C. for 10 minutes with no stirring provided fusing of the doublet particles that withstood 10 minutes of sonication.

The heterodoublet formation proceeded similarly to the homodoublet formation. The final suspension contained sulfate singlets, CML singlets, sulfate homodoublets, CML homodoublets, sulfate-CML heterodoublets, and less than 1% of larger aggregates with various combinations of sulfate and CML particles. The described salting out and quenching of single colloidal particles in the doublet formation process according to the present invention produces a consistent 20% yield of high selectivity homodoublets and heterodoublets in solution with less than 3% of larger particle aggregates.

Optical microscopy performed at a magnification of 40× on heterodoublets formed by methods described in this example allows observation of heterodoublets including a 2.4 micron diameter sulfate PSL particle and a 4.6 micron diameter CML PS particle. Sonication of heterodoublets formed by “salting out and quenching” using a VWR International Model 550T ultrasonicator operated at 117 V, 270 avg Watt power, 40 kHz, results in dissociation of the doublets. Following fusion by heating above the Tg, the particles of the heterodoublets remain associated even after sonication for 10 minutes.

FIG. 6 shows the yield percentage of doublets (homodoublets and heterodoublets), single particles, and larger particle aggregates in the final polymer colloid heterodoublet particle solution of this example. The first set of bars gives the percentage of particles present in the doublet solution formed from the salting out and quenching steps (SQ), the second set is for the doublet solution after the fusing step (SQF), and the third set is for the SQF doublet solution after it is sonicated for 10 minutes using a VWR International Model 550T ultrasonicator operated at 117 V, 270 avg Watt power, 40 kHz. Each experiment is performed a minimum of five times.

The SQ solution, SQF solution, SQF solution after sonication includes CML homodoublets, sulfate homodoublets, CML-sulfate heterodoublets, CML singlets, sulfate singlets, and some 3-mers and 4-mers made of combinations of both types of particles. The same percentage of particle doublets (14.8% doublets) are present in the SQ doublet solution, the SQF doublet solution, and after the SQF doublet solution is sonicated for 10 minutes. Of the total percentage of doublets, 4.2% are CML homodoublets, 5.5% are sulfate homodoublets, and 4.8% are CML-sulfate heterodoublets. Visual evidence and the statistical percentage of singlets, doublets, and larger aggregates produced, show that the CML-sulfate doublets (heterodoublets and homodoublets) formed with the SQP process are permanently fused after the high pressure heating to above their glass transition. The high pressure is used to prevent boiling of water, in this embodiment. For other fluids or mixtures, the atmospheric pressure may be used.

A purification procedure is optionally performed to isolate a desired homodoublet or heterodoublet.

### Example 10

Zeta potentials for CML-sulfate functionalized PSL doublet suspensions are taken as doublet solutions (SQ), both immediately after temperature fusing (SQF) and four days after the fusion. The particle zeta potentials are measured on a Brookhaven Instruments PALS Chase Analysis Light Scattering) zeta potential analyzer. All colloidal particle zeta potentials are measured in a 10 mM KCl solution. The mixture of CML and sulfate functionalized PSL homodoublets and heterodoublets results in a strongly negatively charged zeta potential. As single particles, the zeta potential of the sulfate functionalized PSL particles is −136 mV and the zeta potential of the CML functionalized PSL particles is −96 mV. There is a 2:1 ratio of sulfate to CML particles used, and the zeta potential of the doublet solution is found to be −127 mV. Similar to the zeta potential measurements for the homodoublet solutions, there is a slight statistical decrease in the zeta potential for the CML-sulfate doublet solutions after the fusing step to a value of −115 mV. The zeta potential of the fused (hetero)doublet solution does not statistically change when the zeta potential is again taken four days later.

### Example 11

In this example, 2.4 micron diameter sulfate polystyrene latex particles and 1.54 micron diameter silica microspheres are used to form silica-sulfate particle heterodoublets, silica particle homodoublets, and sulfate polystyrene latex particle homodoublets according to embodiments of methods of the present invention.

Two hundred microliters of a 500 nM KCL solution are added to the particle suspension, for a final ionic strength of 250 mM KCl. The test tube is slowly swirled by hand so that the particles and the salt solution mixed well. At 250 mM KCl, the particles aggregated quickly, and thus the particles are “salted out”. A range of ionic strengths for the salting out step has been tested, and optimized to obtain an effective salt concentration where doublets form with a high yield.

After 60 seconds the aggregation process is quenched by adding 30 mL of deionized water to the test tube, giving a final ionic strength to 3.3 mM KCl and electrostatic repulsions between the similarly charged particles prevent further aggregation.

This procedure results in similar yields of doublets in the final solution compared with the polystyrene-polystyrene doublet formation. The various particles and aggregates are differentially detectable optically due to size differences of the starting singlet particles, since a 2.4 micron moiety of a doublet is easily differentiated from a 1.54 moiety.

The doublets are heated to a temperature above the glass transition temperature of the polystyrene particle for 15 minutes using an autoclave, 120° C., 18 psi, to exceed T_{g} without boiling. These are the same conditions as for the polymer heterodoublets. The silica does not melt at this temperature or have a glass transition; however, by taking the polymer particle above its glass transition, it fuses well to the silica.

Sonication breaks apart all doublets in the absence of a fusion step. Following fusion for 15 minutes using an autoclave, 120° C. (18 psi) and sonication for 10 minutes using an ultrasonicator, the VWR International Model 550T fails to dissociate the silica-sulfate doublets. In contrast, the silica-silica homodoublets are dissociated following sonication after fusion under these conditions.

In a further example, the fusing is done at 92° C., atmospheric pressure, for 10 minutes, to obtain intermediate adhesion strength of silica and PSL, such that the doublets break after 1 or 2 minutes of sonication.

### Example 12

In this example, doublets 3.3 micron diameter amidine polystyrene latex particles and 2.02 micron amine functional melamine formaldehyde particles are used to form doublets according to embodiments of the present invention. The two different types of polymer colloids have different glass transition temperatures, 93° C. for amidine polystyrene latex and greater than 120° C. for amine functional melamine formaldehyde.

Two hundred microliters of a 500 mM KCL solution are added to the particle suspension, for a final ionic strength of 250 mM KCl. The test tube is swirled by hand so that the particles and the salt solution mixed well. At 250 mM KCl, the particles aggregated quickly, and thus the particles are “salted out”. A range of ionic strengths for the salting out step has been tested, and optimized to obtain an effective salt concentration where doublets form with a high yield.

After 60 seconds the aggregation process is quenched by adding 30 mL of deionized water to the test tube, giving a final ionic strength to 3.3 nM KCl and electrostatic repulsions between the similarly charged particles prevent further aggregation.

The doublets are heated to a temperature above the glass transition temperature of both particle compositions for 15 minutes using an autoclave, 120° C., 18 psi, to exceed T_{g} without boiling.

### Example 13

### Metal Doublet Formation

Synthesis of Colloidal Gold:

A 75 milliliter solution containing 0.025 M tetrachloroaurate (HAuCl₄) and 3 wt. % gum Arabic is prepared. A second 75 milliliter solution is prepared containing 0.05 M L-ascorbic acid and 3 wt. % gum arabic. The two 75 milliliter solutions are combined in a 250 mL covered reaction flask and stirred for 48 hours. After stirring for 48 hours, the gold particles are allowed to settle for two hours. The supernatant is drawn off, and the gold particles are rinsed twice with water and resuspended in 100 mL of DI water.

The synthesized colloidal gold particles are examined using Scanning Electron Microscopy and are found to be spherical, having diameters from 0.7 to 1.3 microns. The gold particles have wormlike surfaces when viewed in SEM, as the gold colloids are composed of a tight, spherical aggregation of nanoparticles.

### Synthesis of Colloidal Silver:

A 75 milliliter solution containing 0.167 M silver nitrate and 7 wt. % gum arabic is prepared. A second 75 milliliter solution is prepared containing 0.333 M1-ascorbic acid and 7 wt. % gum arabic. The two 75 milliliter solutions are combined in a 250 mL covered reaction flask and stirred for 24 hours. The supernatant is drawn off, and the silver particles are rinsed twice with water and resuspended in 600 mL DI water.

The synthesized colloidal silver particles have typical diameters ranging from 0.8 to 1.5 microns and are spherical aggregates of silver nanoparticles. The silver particles have a cloudlike surface and had larger degree of asymmetry than the gold particles synthesized as described above.

Table I shows zeta potentials of gold colloidal singlet particles and silver colloidal singlet particles. The zeta potentials of the gold colloidal singlet particles and silver colloidal singlet particles are measured in both DI water and 100 mM KCl.

TABLE I

| | DI Water | 100 mM KCl |
|---|---|---|
| Gold colloidal singlet particles | −49.65 mV | −21.15 mV |
| Silver colloidal singlet particles | −57.98 mV | −26.81 mV |

Doublet Formation from Metal Singlet Particles

Controlled aggregation according to methods of the present invention is used to form metal particle homodoublets and metal particle heterodoublets. Aggregation procedures are performed in glass centrifuge tubes, as the metallic colloids stick to the sides of plastic containers during aggregation procedures.

Gold Homodoublets

Gold colloidal singlet particles are concentrated to a volume fraction of 0.0257 in this example. Gold-gold doublet formation is achieved by adding 40 microliters of 2.5 M KCl to 40 microliters of the concentrated gold solution. This combination is mixed by vortexing it once every minute for the duration of the aggregation time of 20 minutes. After 20 minutes, 5 mL of DI water is added to quench the aggregation, bringing the ionic strength of the solution below 0.02 M.

Silver Homodoublets

The volume fraction of the silver colloidal singlet particles is increased to 0.0646 in this example. Silver-silver doublet formation is achieved by adding 40 microliters of 2.5 M KCl to 40 microliters of the concentrated silver solution. This combination is vortexed once every minute for an aggregation time of 10 minutes. After 10 minutes, 5 mL of DI water is added to quench aggregation, bringing the ionic strength of the solution below 0.02 M.

Gold-Silver Heterodoublets

Gold-silver doublet formation is achieved in this example by combining 25 microliters of a solution having a volume fraction of 0.0257 colloidal gold singlet particles with 15 microliters of a solution having a volume fraction of 0.0646 colloidal silver singlet particles and adding 40 microliters 2.5 M KCl to form a mixture. The mixture is vortexed every minute for 15 minutes. After 15 minutes, 5 mL of DI water is added to quench aggregation, bringing the ionic strength of the mixture below 0.02 M.

Zeta potentials of solutions containing gold homodoublets or silver homodoublets are found to be substantially unchanged from the initial measurements performed on gold colloidal singlet particles or silver colloidal singlet particles, respectively. The zeta potential of the gold-silver heterodoublets is found to be −58.63 mV after quenching and −23.83 mV in 100 mM KCl. The zetaPALS instrument has an uncertainty of 5 to 8 mV, in our experience, for these systems.

FESEM images of gold-gold, silver-silver, and gold-silver doublets show the individual particles of the homodoublets and heterodoublets contacting each other. Example 14. Electrical connectivity between the two metallic spheres in these doublets has been shown. It is known from the literature (e.g., Kline et al, Journal of Physical Chemistry B, 110, 24513, 2006) that gold-silver rods move by an autoelectrophoresis mechanism in 3% H₂O₂ aqueous solutions. The mechanism requires that electrical connectivity exist between the silver and the gold, for transport of electrons. When a dielectric is placed between the two parts, all movement stops.

Gold-silver heterodoublets were placed in a 3% H₂O₂ aqueous solution, and the movement was compared with known predictions of Brownian diffusion, as well as movement of gold-gold homodoublets, which should undergo negligible autoelectrophoresis. It was found that the gold-gold homodoublets moved after about 30 seconds a distance comparable to that expected from only Brownian diffusion, while gold-silver heterodoublets moved at least 10× as far. Continuously recorded images of the autoelectrophoresing heterodoublets makes the non-diffusive movement obvious, and passes the test of electrical connectivity between the gold and silver.

### Example 15

### Synthesis of Silica Nanodoublets:

### Materials

Silica nanocolloids are obtained from commercial sources. Two types are provided: sample TX11490 (22 nm in diameter, volume fraction 0.228) and sample TX11561 (80 nm in diameter, volume fraction 0.185). In addition, a 2.5 M stock KCl solution is prepared.

### Technique for Approximating Nanoparticle Aggregation

Because rapid flocculation time for any usable concentration of nanoparticles is very short, nearly instantaneous, ionic strength is lowered and the stability ratio therefore increased until aggregation occurred on a measurable timescale. To measure aggregation, the silica nanoparticles are measured in a UV/VIS spectrophotometer before and after rapid flocculation. A peak absorbance wavelength of 550 nm is chosen.

To determine ionic concentration for aggregation within a convenient timescale, samples of each of the silica are mixed with varying amounts of the stock 2.5 M KCl solutions diluted with water, and the absorbance at the peak wavelength is measured as a function of time. Ionic strength is increased and decreased according to how fast the particles reached the final absorbance. Synthesis of 22 nm silica nanodoublets

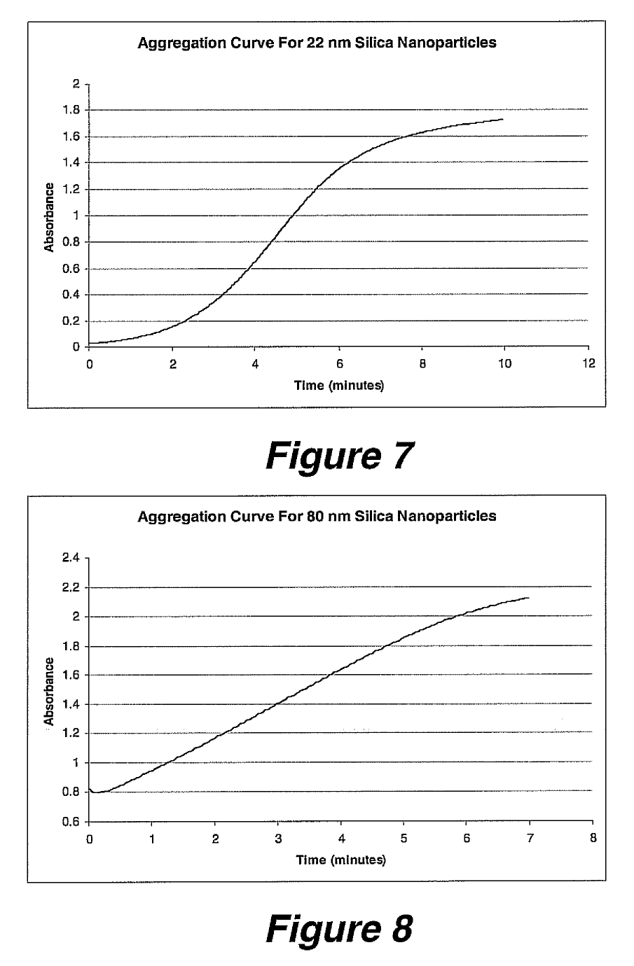

FIG. 7 shows formation of doublets of over time in a final concentration of 1.25 M KCl, volume fraction 0.00570. It is found that these nanodoublets of 22 nm diameter silica single particles are formed on a convenient timescale under the following conditions: KCl concentration: 1.25 M, Volume fraction: 0.00570, Aggregation time: 4.5 minutes.

### Synthesis of 80 nm Silica Nanodoublets

FIG. 8 shows formation of doublets of over time in a final concentration of 0.563 M KCl, volume fraction 0.00717. It is found that these nanodoublets of 80 nm diameter silica single particles are formed on a convenient timescale under the following conditions: KCl concentration: 0.563 M, Volume fraction: 0.00717, Aggregation time: 3 minutes.

Any patents or publications mentioned in this specification are incorporated herein by reference to the same extent as if each individual publication is specifically and individually indicated to be incorporated by reference. In particular, U.S. Provisional Patent Application Ser. No. 60/826,486, filed Sep. 21, 2006, is incorporated herein by reference in its entirety.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

We claim:

1. A method of producing a plurality of particle aggregates, comprising:
stimulating a plurality of particles with an aggregation stimulus to form a plurality of particle aggregates, an individual particle aggregate of the plurality of particle aggregates having member particles comprising at least a first member particle and a second member particle; and
quenching the aggregation stimulus in order to inhibit further particle aggregation.

2. The method of claim 1, further comprising:
fusing member particles to stabilize the particle aggregate.

3. The method of claim 1 wherein at least a portion of the plurality of particles comprises single particles having a shape selected from the group consisting of: spherical, spherical flattened in one region, cubic, ellipsoidal, prolate spheroid, oblate spheroid, rods, plates, discs, toroid, irregular, flattened particles, and hollow particles.

4. The method of claim 1 wherein at least a portion of the plurality of particles comprises single particles which are substantially spherical.

5. The method of claim 1 wherein individual particles of the plurality of particles each independently have a particle diameter in the range of about 1 nanometer to 100 microns, inclusive.

6. The method of claim 1 wherein individual particles of the plurality of particles each independently have a particle diameter in the range of about 10 nanometers to 20 microns, inclusive.

7. The method of claim 1 wherein the member particles have substantially the same composition such that the particle aggregate is a homoaggregate.

8. The method of claim 1 wherein at least two member particles have different compositions such that the particle aggregate is a heteroaggregate.

9. The method of claim 1 wherein the member particles each comprise a material independently selected from the group consisting of: a polymer, a metal, a semiconductor, an oxide, a fluid droplet; and a combination of these.

10. The method of claim 1 comprising a member particle having a core and a coating disposed on the core.

11. The method of claim 10 wherein the core is a metal core and the coating is a polymer coating.

13. The method of claim 1 wherein individual particles of the plurality of particles comprise one or more ionic moieties.

14. The method of claim 1 wherein an incubation time period between the aggregation stimulus and the quenching is in the range of about 0.1-10⁹ times the Smoluchowski rapid flocculation time.

15. The method of claim 2 wherein the fusing comprises heating the plurality of particle aggregates to a temperature at or above the glass transition temperature of a polymer included in a member particle.

16. The method of claim 1, wherein the plurality of particles comprises a plurality of singlet particles.

17. The method of claim 1, wherein the plurality of particles comprises a plurality of particle aggregates, wherein the plurality of particle aggregates comprises predominantly particle aggregates having a specified number of member particles.

18. A method of producing a plurality of particle aggregates, comprising:
stimulating a plurality of particles with an aggregation stimulus for an incubation time to form a plurality of particle aggregates, an individual particle aggregate of the plurality of particle aggregates having member particles comprising at least a first member particle and a second member particle; and
quenching the aggregation stimulus in order to inhibit further particle aggregation.

19. The method of claim 18, further comprising incubating the particle aggregates at a temperature at or above the glass transition temperature of at least one of the member particles.

20. The method of claim 19, further comprising contacting the particle aggregates with a solvent, effectively reducing the glass transition temperature of at least one of the member particles.

21. The method of claim 18 wherein the plurality of particles is a colloidal dispersion of particles in a continuous phase, wherein the aggregation stimulus is a change in ionic strength of the continuous phase, a change in pH of the continuous phase, addition of a particle solvent to the continuous phase, a change in temperature of the continuous phase; or a combination thereof.
